(19) United States
(12) Patent Application Publication
(10) Pub. No.: US 2017/0164715 A1
(43) Pub. Date: Jun. 15, 2017

(54) Nail Clipping Cylinder

(71) Applicant: Anthony Edwards, Miami, FL (US)

(72) Inventor: Anthony Edwards, Miami, FL (US)

(21) Appl. No.: 15/380,675

(22) Filed: Dec. 15, 2016

Related U.S. Application Data
(60) Provisional application No. 62/267,565, filed on Dec. 15, 2015.

(51) Int. Cl. A45D 29/02; G08B 5/36; F21V 33/00

(52) U.S. Cl. CPC A45D 29/023; F21V 33/004; G08B 5/36; A45D 2029/026

(57) ABSTRACT

A nail clipping cylinder provides a layer of memory foam upon which the tip of the finger or thumb rests when inserted, a blade and one or more sensors which detect the presence of the finger or thumb, extend grippers to gently hold the tip of the finger or toe, detect the contours of the portion of the nail which is to be removed, and position the blade as necessary to trim and remove that portion. Preferably, this detection and positioning system is comprised of a fiber-optic camera, image recognition software, and a servomotor. The user may then press a button to activate the blade. The nail is safely trimmed and the clipping is retained by the cylinder for later disposal. The cylinder is manufactured entirely from recycled materials.

### CROSS-REFERENCE TO RELATED APPLICATIONS

This Application claims the benefit of U.S. Provisional Application No. 62/267,565, filed Dec. 15, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to personal care devices and accessories, and in particular to a nail clipping cylinder. For many people, the simple task of clipping their fingernails and toenails can be a challenge. The elderly and disabled may lack the coordination needed for the task. People recovering from certain diseases and injuries, as well as overweight individuals, may have trouble reaching their toenails to trim them. Fortunately, technology has provided an answer. A nail clipping cylinder, which easily identifies the portion of the nail to be trimmed, holds the finger or toe securely, trims the nail cleanly and safely, and retains the clipping for easy disposal, would resolve this problem.

### SUMMARY OF THE INVENTION

Accordingly, the invention is directed to a nail clipping cylinder. The cylinder is preferably between four and six inches in length, and between 0.5 and 0.75 inch in diameter. The cylinder provides a layer of memory foam upon which the tip of the finger or thumb rests when inserted. The cylinder provides a blade and one or more sensors which detect the presence of the finger or thumb, extend grippers to gently hold the tip of the finger or toe, detect the contours of the portion of the nail which is to be removed, and position the blade as necessary to trim and remove that portion. Preferably, this detection and positioning system is comprised of a fiber-optic camera, image recognition software, and a servomotor. The user may then press a button to activate the blade. The nail is safely trimmed and the clipping is retained by the cylinder for later disposal. The cylinder is manufactured entirely from recycled materials.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front view of the first exemplary embodiment, displaying the cylinder 10, the opening 11, the memory foam 12, and the blade 13.

FIG. 2 is a side view of the first exemplary embodiment, displaying the cylinder 10, and the socket 14.

FIG. 3 is a front perspective view of the first exemplary embodiment, displaying the cylinder 10, the opening 11, the memory foam 12, and the blade 13.

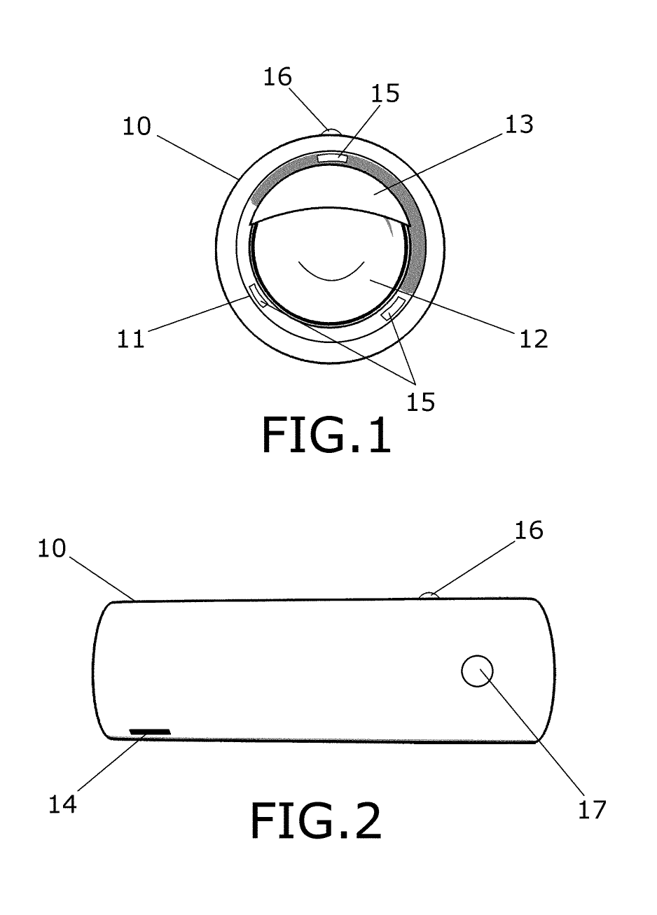

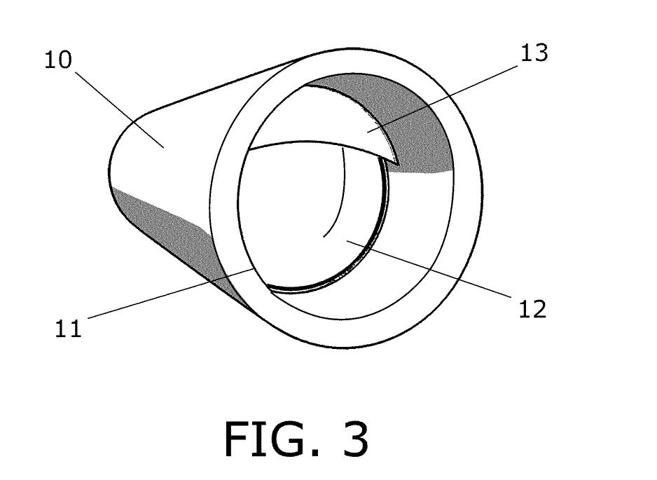

### DETAILED DESCRIPTION OF THE INVENTION

Referring now to the invention in more detail, the invention is directed to a nail clipping cylinder 10.

The first exemplary embodiment is comprised of a cylinder 10 which is preferably between four and six inches in length, and between 0.5 and 0.75 inch in diameter. The front end 11 of the cylinder 10 provides a circular opening 11 into a hollow interior. The interior of the cylinder 10 provides a layer of memory foam 12 upon which the tip of the finger or thumb rests when inserted into the opening 11.

The cylinder 10 provides a movable blade 13 and one or more sensors 15 which detect the presence of the finger or thumb. The device may provide extendable grippers to gently hold the tip of the finger or toe, detect the contours of the portion of the nail which is to be removed, and position the blade 13 as necessary to trim and remove that portion. Preferably, sensors 15 are comprised of a fiber-optic camera, image recognition software, and the movable blade is moved with one or more servomotors. Alternate methods, using other components or combinations of components, are contemplated. The system then notifies the user that the blade 13 has been properly positioned, via an indicator light 16 or some other means, and the user may then press a button 17 to activate the blade 13. The nail is safely trimmed and the clipping is retained by the cylinder 10 for later disposal.

The cylinder 10 is manufactured entirely from recycled materials. The cylinder 10 may provide a removable rod and handle, such that an injured, elderly, or disabled user may easily insert a toe into the opening 11 of the cylinder 10 without bending over. The cylinder 10 is preferably battery-powered. Additionally, the cylinder 10 may be powered by standard household current, and provides a removable power cord which may be plugged into any wall outlet. The power cord may be inserted into a socket 14, which is provided on the lower surface of the cylinder 10, to provide power.

Electronic components of the cylinder 10 preferably include a memory device, a microprocessor, one or more replaceable batteries of a standard type such as AA batteries, an on/off switch, the socket 14 and power cord, a fiber-optic camera, image recognition software, and a servomotor.

To use the first exemplary embodiment, the user inserts a finger or toe into the opening 11 of the cylinder 10, such that the tip of the finger or toe rests against the layer of memory foam 12, which forms around the tip of the finger or toe. The cylinder 10 automatically detects the presence of the finger or thumb, extends grippers to gently hold the tip of the finger or toe, detects the contours of the portion of the nail which is to be removed, and positions the blade 13 as necessary to trim and remove that portion. The cylinder 10 then signals the user, via an indicator light or some other means, that the blade 13 has been properly positioned. The user may then press a button, which activates the blade 13, and the blade 13 safely and securely trims the nail. The grippers then retract. The user may remove the finger or toe from the opening 11, and repeat the procedure for other fingers and toes. The clippings are retained in an internal compartment, which may be emptied by the user at a later time.

The cylinder 10, the blade 13, the socket 14, the camera, the memory device, the microprocessor, and the servomotor are preferably manufactured from rigid, durable materials which are recycled, such as steel, aluminum alloy, brass, and plastic. The memory foam 12 is preferably manufactured from a flexible, durable material which is recycled, such as foam rubber. The grippers are preferably manufactured from a rigid, durable material which is recycled, such as plastic or steel, coated with a flexible, durable material which is recycled, such as foam rubber. The power cord is preferably manufactured from recycled, braided copper alloy wire sheathed in recycled plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A nail clipping cylinder, comprising:
a. a cylinder having a front end and a hollow interior;
b. said front end providing a circular opening;
c. a memory foam pad located within the hollow interior;
d. a blade located on an interior surface of the cylinder;
e. said blade being movable within the interior of the cylinder;
f. one or more sensors;
g. said sensors being configured to detect the position of a digit having a nail;
wherein a user places the digit having a nail within the cylinder through the circular opening, the one or more sensors detect the position of the nail of the digit, the blade is positioned to cut the nail, the blade cuts the nail, and the digit is removed.

2. The nail clipping cylinder of claim 1, wherein said cylinder is between four and six inches in length.

3. The nail clipping cylinder of claim 1, wherein said cylinder is between 0.5 and 0.75 inches in diameter.

4. The nail clipping cylinder of claim 2, wherein said cylinder is between 0.5 and 0.75 inches in diameter.

5. The nail clipping cylinder of claim 1, wherein said one or more sensors comprises at least one fiber-optic camera.

6. The nail clipping cylinder of claim 1, further comprising an indicator light; said indicator light illuminating when said blade is positioned to cut the nail.

7. The nail clipping cylinder of claim 1, further comprising a button; said button being configured to activate the blade to cut the nail.

8. The nail clipping cylinder of claim 6, further comprising a button; said button being configured to activate the blade to cut the nail when the indicator light illuminates to indicated the blade is in position to cut the nail.
